(19) United States
(12) Patent Application Publication
(10) Pub. No.: US 2014/0153453 A1
(43) Pub. Date: Jun. 5, 2014

(54) METHOD AND APPARATUS FOR LIMITING A DOWNLINK SUBFRAME IN A TDD MODE

(71) Applicants: Donghyun Park, Seoul (KR); Sungkwon Hong, Seoul (KR)

(72) Inventors: Donghyun Park, Seoul (KR); Sungkwon Hong, Seoul (KR)

(73) Assignee: Pantech Co., Ltd., Seoul (KR)

(21) Appl. No.: 14/232,969

(22) PCT Filed: Jul. 5, 2012
(86) PCT No.: PCT/KR2012/005343

§ 371 Date: Jan. 15, 2014

(30) Foreign Application Priority Data
Jul. 15, 2011 (KR) 10-2011-0070595

(51) Int. Cl. H04L 5/14

(52) U.S. Cl. CPC H04L 5/1469
USPC 370/280

(57) ABSTRACT

The present description relates to a method and apparatus for limiting a downlink subframe in a time division duplex (TDD) mode. The method for limiting a downlink subframe in a TDD mode according to one embodiment of the present description enables a base station, which controls a cell operating in a TDD scheme, to: transmit cell-specific TDD uplink-downlink configuration information and terminal-specific TDD uplink-downlink configuration information of the cell to a user terminal having low power consumption; and transmit uplink allocation information or response control information to the data previously received from the user terminal in a first downlink subframe according to the cell-specific TDD configuration information and terminal-specific TDD configuration information provided to the user terminal. The terminal-specific TDD configuration information indicates one or more candidate subframes which are portions of downlink subframes in the cell.

### CROSS-REFERENCE TO RELATED APPLICATIONS

This application is the National Stage Entry of International Application PCT/KR2012/005343, filed on Jul. 5, 2012 and claims priority from and the benefit of Korean Patent Application No. 10-2011-0070595, filed on Jul. 15, 2011, all of which are incorporated herein by reference in their entireties for all purposes as if fully set forth herein.

### BACKGROUND

1. Field

The present invention relates to a method and an apparatus for setting a limited downlink subframe for a user equipment having low power consumption and transmitting/receiving data to/from the user equipment through the limited downlink subframe in a Time division Duplex (TDD) system.

2. Discussion of the Background

With the progress of communication systems, consumers such as companies and individuals have used a wide variety of wireless terminals. Current mobile communication systems such as 3^{rd} Generation Partnership Project Long Term Evolution (3GPP LTE) and 3GPP LTE Advanced (LTE-A), need to develop a technology for a system capable of transmitting a large amount of data coming close to that transmitted through a wired communication network, as a high-speed and high-capacity communication system capable of transmitting and receiving various data such as images and wireless data beyond voice-oriented services. Data can be efficiently transmitted through multiple component carriers in a scheme for transmitting a large amount of data. Meanwhile, a TDD system which uses a particular frequency band to transmit and receive data can transmit and receive data in such a manner that the particular frequency band is divided into time slots. In this case, in the TDD system, a timing of transmitting response information to the transmission and reception of data may change according to a scheme for setting uplink (UL) and downlink (DL).

Recently, a combination of user equipments which puts emphasis on the LTE or LTE-A communication system and low power consumption is being discussed. Low power consumption is to reduce the power consumption of a user equipment. For example, the low power consumption is a feature considered in the case of designing an apparatus or a user equipment which provides a communication function such as Machine Type Communication (MTC) which is not performed by a mobile phone, and needs to enable the prevention of the waste of power by causing the apparatus to minimally perform unnecessary communication.

### SUMMARY

Therefore, an aspect of the present invention is to reduce the consumption of power in such a manner as to limit an operation required in a downlink subframe by limiting the downlink subframe when a user equipment which needs to consume low power operates in a TDD mode in a wireless communication system.

Another aspect of the present invention is to enable the adjustment of the consumption of power according to characteristics of each user equipment by limiting a downlink subframe for each user equipment and by differently setting a periodicity for performing a main operation, which is intended to be performed in the downlink subframe, according to the user equipments.

In accordance with an aspect of the present invention, there is provided a method for limiting a downlink subframe in a Time Division Duplex (TDD) mode by a Base Station (BS) that controls a cell operating in a TDD scheme. The method includes: transmitting cell-specific TDD uplink-downlink (UL-DL) configuration information of the cell and User Equipment (UE)-specific TDD UL-DL configuration information to a UE having low power consumption; and transmitting UL grant information or response control information to data, which has previously been received from the UE, to the UE in a first DL subframe according to the cell-specific TDD UL-DL configuration information and the UE-specific TDD UL-DL configuration information provided to the UE, wherein the UE-specific TDD UL-DL configuration information indicates any one or more of candidate subframes corresponding to some of DL subframes in the cell.

In accordance with another aspect of the present invention, there is provided a method for limiting a downlink subframe in a Time Division Duplex (TDD) mode by a User Equipment (UE) having low power consumption connecting to a cell operating in a TDD scheme. The method includes: receiving cell-specific TDD uplink-downlink (UL-DL) configuration information of the cell and UE-specific TDD UL-DL configuration information, from a Base Station (BS) that controls the cell; and receiving UL grant information or response control information to data, which the UE has previously transmitted, from the BS in a first DL subframe according to the cell-specific TDD UL-DL configuration information and the UE-specific TDD UL-DL configuration information, wherein the UE-specific TDD UL-DL configuration information indicates any one or more of candidate subframes corresponding to some of DL subframes in the cell.

In accordance with still another aspect of the present invention, there is provided a Base Station (BS) that controls a cell operating in a Time Division Duplex (TDD) scheme. The BS includes: a transmission unit that transmits a wireless signal to a User Equipment (UE); a reception unit that receives a wireless signal from the UE; and a control unit that controls the transmission unit and the reception unit, wherein the control unit generates cell-specific TDD uplink-downlink (UL-DL) configuration information of the cell and UE-specific TDD UL-DL configuration information with respect to the UE having low power consumption, and controls the transmission unit to transmit the generated cell-specific TDD UL-DL configuration information and UE-specific TDD UL-DL configuration information to the UE; and wherein the control unit controls the transmission unit to transmit UL grant information or response control information to data that the BS has previously received from the UE, to the UE in a first DL subframe according to the cell-specific TDD UL-DL configuration information and the UE-specific TDD UL-DL configuration information, which are provided to the UE, wherein the UE-specific TDD UL-DL configuration information indicates any one or more of candidate subframes corresponding to some of DL subframes in the cell.

In accordance with yet another aspect of the present invention, there is provided a User Equipment (UE) having low power consumption connecting to a cell operating in a Time Division Duplex (TDD) scheme. The UE includes: a transmission unit that transmits a wireless signal to a Base Station (BS); a reception unit that receives a wireless signal from the BS; and a control unit that controls the transmission unit and the reception unit, wherein the reception unit receives cell-specific TDD uplink-downlink (UL-DL) configuration information of the cell and UE-specific TDD UL-DL configuration information, from the BS that controls the cell; and wherein the control unit controls the reception unit to receive UL grant information or response control information to data that the UE has previously transmitted, from the BS in a first DL subframe according to the cell-specific TDD UL-DL configuration information and the UE-specific TDD UL-DL configuration information, wherein the UE-specific TDD UL-DL configuration information indicates any one or more of candidate subframes corresponding to some of DL subframes in the cell.

### BRIEF DESCRIPTION OF THE DRAWINGS

FIG. 1 illustrates a wireless communication system, to which embodiments of the present invention are applied.

FIG. 2 is a view illustrating the control of PDCCH scheduling of a user equipment in a bitmap scheme according to another embodiment of the present invention.

FIG. 3 is a view illustrating a configuration of uplink and downlink subframes between a user equipment and a base station, to which a TDD configuration for low power consumption is applied, according to an embodiment of the present invention.

FIG. 4 is a view illustrating a configuration of uplink and downlink subframes between a user equipment and a base station, to which a TDD configuration for low power consumption is applied, according to another embodiment of the present invention.

FIG. 5 is a view illustrating an example of transmitting a PUSCH when a TDD configuration has a value of 0 in Table 2 and a PDCCH scheduling periodicity is shorter than or equal to a radio frame, according to an embodiment of the present invention.

FIG. 6 is a view illustrating an example of the transmission of a PUSCH by a user equipment for low power consumption when TTI bundling is set, according to an embodiment of the present invention.

FIG. 7 is a flowchart illustrating a process in which a base station limits a downlink subframe and transmits/receives information to/from a user equipment through the limited downlink subframe in a TDD mode, according to an embodiment of the present invention.

FIG. 8 is a flowchart illustrating a process in which a base station limits a downlink subframe and transmits/receives information to/from a user equipment through the limited downlink subframe in a TDD mode, according to an embodiment of the present invention.

FIG. 9 is a flowchart illustrating a process in which a user equipment having low power consumption limits a downlink subframe and transmits/receives information to/from a base station through the limited downlink subframe in a TDD mode, according to an embodiment of the present invention.

FIG. 10 is a flowchart illustrating a process in which a user equipment having low power consumption limits a downlink subframe and transmits/receives information to/from a is base station through the limited downlink subframe in a TDD mode, according to an embodiment of the present invention.

FIG. 11 is a block diagram illustrating a configuration of a base station according to an embodiment of the present invention.

FIG. 12 is a block diagram illustrating a configuration of a user equipment having low power consumption according to an embodiment of the present invention.

### DETAILED DESCRIPTION OF THE ILLUSTRATED EMBODIMENTS

Hereinafter, embodiments of the present invention will be described in detail with reference to the accompanying drawings. It should be noted that in assigning reference numerals to elements in the drawings, the same elements will be designated by the same reference numerals although they are illustrated in different drawings. Further, in the following description of the present invention, a detailed description of known functions and configurations incorporated herein will be omitted when it may make the subject matter of the present invention rather unclear.

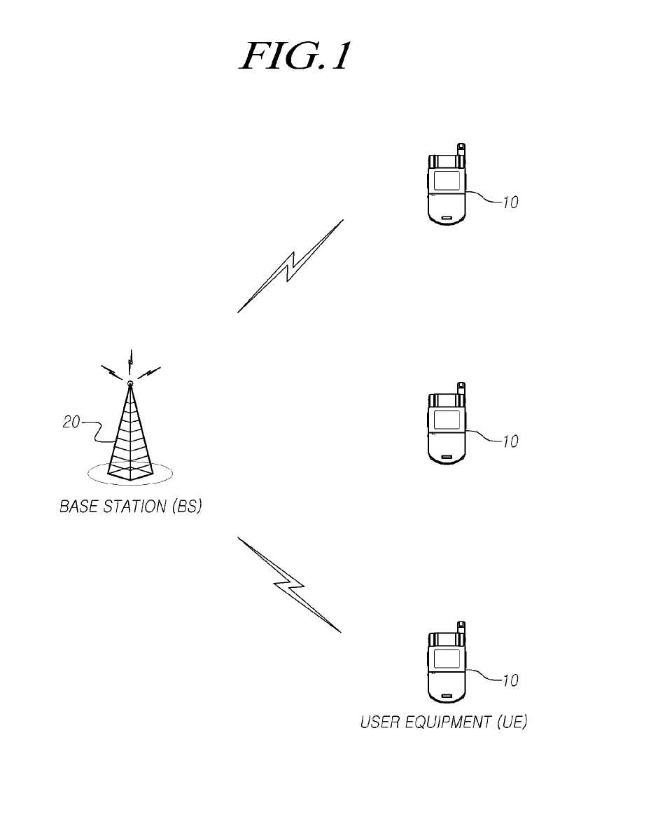

FIG. 1 illustrates a wireless communication system, to which embodiments of the present invention are applied.

The wireless communication system is widely arranged in order to provide various communication services, such as voice, packet data, and the like.

Referring to FIG. 1, the wireless communication system includes a User Equipment (UE) 10 and a Base Station (BS) or an evolved Node-B (eNB) 20. In this specification, the UE 10 has a comprehensive concept implying a terminal in wireless communication. Accordingly, the UEs should be interpreted as a concept including a Mobile Station (MS), a User Terminal (UT), a Subscriber Station (SS), a wireless device, and the like in Global System for Mobile Communications (GSM) as well as User Equipments (UEs) in Wideband Code Division Multiple Access (WCDMA), Long Term Evolution (LTE), High Speed Packet Access (HSPA), and the like.

The BS 20 or a cell usually refers to a station communicating with the UE 10, and may be called different terms, such as a Node-B, an eNB, a sector, a site, a Base Transceiver System (BTS), an Access Point (AP), and a relay node.

Specifically, in this specification, the BS 20 or the cell should be interpreted as having a comprehensive meaning indicating a partial area or a function covered by a Base Station Controller (BSC) in Code Division Multiple Access (CDMA), by a Node-B in Wideband Code Division Multiple Access (WCDMA), or by an eNB or a sector (or a site) in LTE. Accordingly, the BS 20 or the cell has a comprehensive meaning including various coverage areas such as a megacell, a macrocell, a microcell, a picocell, a femtocell, a communication range of a relay node, and the like.

In this specification, the UE 10 and the BS 20, which are two transmission and reception subjects used to implement the art or the technical idea described in this specification, are used as a comprehensive meaning, and are not limited by a particularly designated term or word. Here, the term “uplink (UL)” refers to a scheme for performing transmission and reception of data by the UE 10 with respect to the BS 20, and the term “downlink (DL)” refers to a scheme for performing transmission and reception of data by the BS 20 with respect to the UE 10.

There is no limit to multiple access schemes applied to the wireless communication system. For example, use may be made of various multiple access schemes, such as Code Division Multiple Access (CDMA), Time Division Multiple Access (TDMA), Frequency Division Multiple Access (FDMA), Orthogonal Frequency Division Multiple Access (OFDMA), OFDM (Orthogonal Frequency Division Multiplexing)-FDMA, OFDM-TDMA, and OFDM-CDMA. An embodiment of the present invention may be applied to the allocation of resources in the field of asynchronous wireless communications which have gone through GSM, WCDMA and HSPA, and evolve into LTE and LTE-advanced, and in the field of synchronous wireless communications which evolve into CDMA, CDMA-2000 and Ultra Mobile Broadband (UMB). The present invention should not be interpreted as being limited to or restricted by a particular wireless communication field, but should be interpreted as including all technical fields to which the spirit of the present invention can be applied.

In this regard, use may be made of a Time Division Duplex (TDD) scheme in which UL transmission and DL transmission are performed at different times. Alternatively, use may be made of a Frequency Division Duplex (FDD) scheme in which UL transmission and DL transmission are performed at different frequencies.

Also, in a system such as LTE or LTE-A, a specification is established by configuring UL and DL based on one component carrier or one component carrier pair. In UL and DL, control information is transmitted through a control channel, such as a Physical Downlink Control CHannel (PDCCH), a Physical Control Format Indicator CHannel (PCFICH), a Physical Hybrid ARQ Indicator CHannel (PHICH), a Physical Uplink Control CHannel (PUCCH), or the like. Also, a data channel, such as a Physical Downlink Shared CHannel (PDSCH), a Physical Uplink Shared CHannel (PUSCH), or the like, is configured, and then is used to transmit data.

Meanwhile, time points are different between DL and UL in TDD. When there exist various TDD configurations, the time points may also vary.

Table 1 below shows TDD configurations. It can be noted from Table 1 that the respective TDD configurations have different UL-DL subframe transmission timings.

TABLE 1
Uplink-downlink configurations

| | Downlink- | | | | | | | | | | |
|---|---|---|---|---|---|---|---|---|---|---|---|
| | to- | | | | | | | | | | |
| | Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, an area indicated by D represents DL and an area indicated by U represents UL, in a radio frame corresponding to 10 subframes. S represents a special subframe, which switches from DL to UL and has a DL-to-UL switch-point periodicity.

Meanwhile, when one of the TDD configurations is used, the UE may previously know which time point corresponds to DL and which time point corresponds to UL. Such information enables the UE to make a prediction in advance and operate based on a result of the prediction. For example, a method for using only some of UL and DL subframes in a TDD system may be applied to a UE activated during only a predetermined time period (e.g., a UE aimed at low power consumption as in the case of Machine Type Communication (MTC)).

Hereinafter, in this specification, a description will be made of a method which can limit PDCCH scheduling in order to minimize power consumption in a TDD system and can be applied to the UE aimed at low power consumption. Herein, the UE described below connects to a wireless network, and transmits/receives signals. Examples of the UE may is include communication terminals which not only perform telephone calls and data transmission but also have mechanisms such as MTC and Internet of Thing (IoT).

In this specification, it is intended that efficient data transmission/reception can be made and low power can be consumed by performing communication in a TDD mode (or scheme) and by limiting a time range in which a PDCCH can be received.

Examples of limiting a DL subframe according to a first embodiment of the present invention are shown in Tables 2, 3 and 4 below.

TABLE 2
Cell-specific PDCCH scheduling in TDD

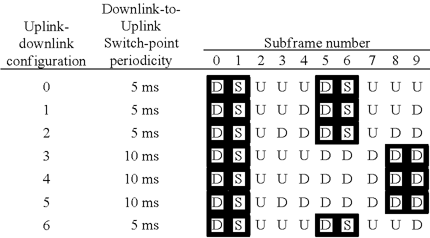

In Table 2, DL subframes are limited each of which requires the UE to monitor the reception
of a PDCCH. In subframes (i.e., subframes 0, 1, 5 and 6 in the case of UL-DL
configurations 0, 1, 2 and 6) shaded among DL subframes indicated by D In Table 2, DL
is set to be activated. In the case of UL-DL configurations 3, 4 and 5, DL is set to be
activated in subframes 0, 1, 8 and 9. Also, PDCCH scheduling may be performed on the
limited subframes shown in Table 2 at longer intervals, by providing separate PDCCH
monitoring configuration information to an individual UE. Hereinafter, the limited DL
subframes, subframes 0, 1, 5 and 6 are referred to as “candidate subframes” in the case of
TDD UL-DL configurations 0, 1, 2 and 6, and subframes 0, 1, 8 and 9 are referred to as
“candidate subframes” in the case of TDD UL-DL configurations 3, 4 and 5.

In other words, Table 2 limits an opportunity for the transmission of a PDCCH by the eNB or an opportunity for the monitoring of the PDCCH by the UE, which is matched to the transmission of the PDCCH by the eNB. Specifically, the BS can perform PDCCH scheduling with respect to the UE only in the candidate subframes (i.e., subframes 0, 1, 5 and 6 in the case of TDD UL-DL configurations 0, 1, 2 and 6, and subframes 0, 1, 8 and 9 in the case of TDD UL-DL configurations 3, 4 and 5). However, an accurate PDCCH scheduling timing may be determined according to UE-specific signaling from the BS. The PDCCH scheduling timing signifies the transmission of a PDCCH by the eNB or the monitoring of the PDCCH by the UE, which is matched to the transmission of the PDCCH by the eNB. Hereinafter, PDCCH scheduling signifies the transmission of a PDCCH from the point of view of the BS, and signifies the monitoring of a PDCCH from the point of view of the UE. In other words, the objective name of this technology is scheduling, but the BS or UE can use this technology as transmission or monitoring when the BS or UE performing the scheduling uses this technology. The BS receives a report on a low power requirement or the state of a battery that the UE has (e.g., the is capability of the UE) from the UE, and transmits the relevant configuration information on an appropriate PDCCH scheduling opportunity to the relevant UE through Radio Resource Control (RRC) signaling with reference to Table 3 below. The capabilities of the UE may be determined based on information such as “low battery” or “low data rate” in the case of the UE requiring low power consumption as in the case of MTC.

Table 3 below is an embodiment of the present invention which shows PDCCH scheduling information which may be set for an individual UE based on Table 2.

TABLE 3
PDCCH scheduling for each UE in TDD

| PDCCH_{DL}_{_{—}}_{Index} | Periodicity (ms) | Offset | Subframe number |
|---|---|---|---|
| 0 | 5 | 0 | (subframe #0, 5) only for TDD configuration 0, 1, 2, 6 |
| 1 | 5 | 1 | (subframe #1, 6) only for TDD configuration 0, 1, 2, 6 |
| 2 | 8 | 0 | (subframe #0, 8) only for TDD configuration 3, 4, 5 |
| 3 | 8 | 1 | (subframe #1, 9) only for TDD configuration 3, 4, 5 |
| 4 | 10 | 0 | (subframe #0) for All TDD configuration |
| 5 | 10 | 1 | (subframe #1) for All TDD configuration |
| 6 | 10 | 2 | (subframe #5) only for TDD configuration 0, 1, 2, 6 |
| 7 | 10 | 3 | (subframe #6) only for TDD configuration 0, 1, 2, 6 |
| 8 | 10 | 4 | (subframe #8) only for TDD configuration 3, 4, 5 |
| 9 | 10 | 5 | (subframe #9) only for TDD configuration 3, 4, 5 |
| 10 | 20 | 0 | (subframe #0) for All TDD configuration |
| 11 | 20 | 1 | (subframe #1) for All TDD configuration |
| 12 | 20 | 2 | (subframe #5) only for TDD configuration 0, 1, 2, 6 |
| 13 | 20 | 3 | (subframe #6) only for TDD configuration 0, 1, 2, 6 |
| 14 | 20 | 4 | (subframe #8) only for TDD configuration 3, 4, 5 |
| 15 | 20 | 5 | (subframe #9) only for TDD configuration 3, 4, 5 |
| 16 | 40 | 0 | (subframe #0) for All TDD configuration |
| 17 | 40 | 1 | (subframe #1) for All TDD configuration |
| 18 | 40 | 2 | (subframe #5) only for TDD configuration 0, 1, 2, 6 |
| 19 | 40 | 3 | (subframe #6) only for TDD configuration 0, 1, 2, 6 |
| 20 | 40 | 4 | (subframe #8) only for TDD configuration 3, 4, 5 |
| 21 | 40 | 5 | (subframe #9) only for TDD configuration 3, 4, 5 |
| 22 | — | — | (subframe #0, 1, 5, 6) only for TDD configuration 0, 1, 2, 6 |
| 23 | — | — | (subframe #0, 1, 8, 9) only for TDD configuration 3, 4, 5 |

The UE may monitor a PDCCH according to PDCCH_{DL}_{_{—}}_{Index} shown in Table 3. When the UE receives PDCCH_{DL}_{_{—}}_{Index}, the UE may detect a periodicity and an offset. Through the detection of the periodicity and the offset, the UE may identify which subframe is used to transmit the PDCCH. For example, when PDCCH_{DL}_{_{—}}_{Index} has a value of 0, a periodicity becomes 5 and an offset becomes 0. This example indicates that the UE monitors that a PDCCH is transmitted in subframe #0 and subframe #5 based on 5 ms (i.e., in a unit of 5 subframes). In Table 2, subframe #0 and subframe #5 are available in the case of the TDD configurations 0, 1, 2 and 6. When the UE receives one of particular configuration values shown in Table 2 and receives the value of PDCCH_{DL}_{_{—}}_{Index}, the UE may identify that the PDCCH scheduling has performed in subframe #0 and subframe #5.

In another embodiment of the present invention, when PDCCH_{DL}_{_{—}}_{Index} has a value of 15, a periodicity becomes 20 and an offset becomes 5. Another embodiment of the present invention indicates that a PDCCH is scheduled based on 20 ms (i.e., in a unit of 20 subframes or 2 radio frames). Also, it is scheduled to transmit a PDCCH in subframe #0. Another embodiment of the present invention is implemented when one of the TDD configurations 3, 4 and 5 is set in Table 2.

Table 3 is an embodiment of the present invention, and may be set for more periodicities longer than 40 ms. Table 3 is a method in which the UE and the BS can share information on a subframe used to monitor a PDCCH when positions of pre-scheduled PDCCHs are determined in the form of a table and both the UE and the BS share the value of PDCCH_{DL}_{_{—}}_{Index}. Alternatively, the BS may designate information in a bitmap scheme.

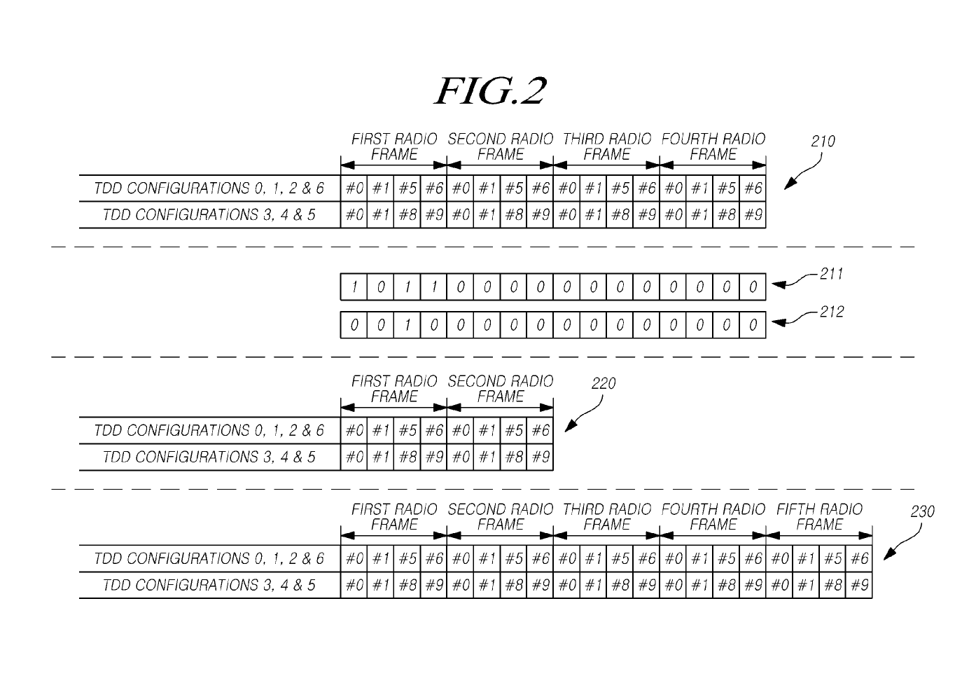

FIG. 2 is a view illustrating the control of PDCCH scheduling of a UE in a bitmap scheme according to another embodiment of the present invention.

Referring to FIG. 2, an available DL subframe (i.e., a candidate subframe) is limited according to a TDD configuration. The number of candidate subframes which are DL subframes available in a TDD configuration for each cell is equal to 4. Accordingly, scheduling information (i.e., monitoring information) on which one of the 4 DL subframes is used to transmit a PDCCH may be set in a bitmap.

Reference numeral 210 denotes a case of a 16-bit bitmap which is based on 4 radio frames.

When 0 is set for each subframe, a PDCCH is not transmitted. When 1 is set for each subframe, the PDCCH is transmitted.

When a TDD configuration in Table 2 has a value of 1 and bitmap values that the UE has received from the BS in order to monitor a PDCCH are as denoted by reference numeral 211, the bitmap values are matched to positions of respective subframes denoted by reference numeral 210. Specifically, the bitmap values signify that PDCCH monitoring occurs in subframes #0, #5 and #6 of the first radio frame but PDCCH monitoring does not occur in subframes of the following three radio frames.

When a TDD configuration in Table 2 has a value of 3 and bitmap values that the UE has received from the BS in order to monitor a PDCCH are as denoted by reference is numeral 212, the bitmap values signify that PDCCH monitoring occurs in subframes #8 of the first radio frame but PDCCH monitoring does not occur in subframes of the following three radio frames. This example corresponds to a case in which PDCCH_{DL}_{_{—}}_{Index} in Table 3 has a value of 20.

In addition, PDCCH monitoring may be variously set through a bitmap, according to a periodicity, such as a scheme for setting a bitmap based on 2 radio frames (i.e., a time length corresponding to the 2 radio frames) which is denoted by reference numeral 220, a scheme for setting a bitmap based on 5 radio frames which is denoted by reference numeral 230, and the like. The PDCCH monitoring information shown in Table 3 and FIG. 2 may be variously selected according to an implementation scheme.

When a subframe enabling DL is limited in a TDD configuration for each cell as shown in Table 2 and a DL periodicity and a DL time point according to TDD are set for each UE by using the scheme shown in Table 3 and FIG. 2, the BS transmits a signal to the relevant UE only in a limited DL subframe, and the UE also stands by for receiving a signal only in a preset DL subframe. Accordingly, the UE can consume low power.

The BS may first transmit a cell-specific PDCCH scheduling pattern, that is, a PDCCH transmission pattern or a preset pattern (i.e., candidate subframes such as subframes 0, 1, 5 and 6 in the case of the configurations 0, 1, 2 and 6, and subframes 0, 1, 8 and 9 in the case of the configurations 3, 4 and 5, in Table 2), as shown in Table 2 through system information (SI). Alternatively, the BS may use a predefined pattern (i.e., a fixed pattern)

Also, the eNB actually signals to the UE for a subframe (i.e., a DL subframe in which blind decoding for finding a PDCCH is attempted) that the UE is to monitor, by using the received or predefined pattern. Here, the signaling may generate PDCCH_{DL}_{_{—}}_{Index} as shown in Table 3, and may notify the UE of the subframe that the UE is to monitor, through a periodicity and an offset. Also, a determination may be made of a subframe in which cell-specific PDCCH monitoring is performed in the form of a bitmap as illustrated in FIG. 2, or a subframe from among predefined pattern subframes (i.e., candidate subframes) in which monitoring is actually performed. Accordingly, a subframe in which scheduling can be performed is agreed upon between the eNB and the UE. The PDCCH scheduling timing signifies the transmission of a PDCCH by the eNB or the monitoring of the PDCCH by the UE, which is matched to the transmission of the PDCCH by the eNB.

Meanwhile, in the case of using Tables 2 and 3 and FIG. 2, namely, in a scheme for limiting the number of DL subframes enabling PDCCH scheduling, a timing enabling the reception a PHICH and a timing enabling the transmission of a UL grant may be affected in the case of the BS. In this regard, a scheme for a new timing needs to be proposed. In other words, when a DL subframe is limited as in the scheme which is set in Tables 2 and 3 and FIG. 2, mapping may be newly defined between UL subframes used to response control information such as Acknowledge/Negative Acknowledge (Ack/Nack) for a DL subframe.

Table 4 below shows mapping between UL subframes mapped to DL subframes according to the above-described scheme for limiting a DL subframe. Specifically, Table 4 below shows a mapping relation between UL subframes, in each of which a PUSCH is transmitted according to a PHICH or a UL grant, which has been transmitted in DL subframe n. Table 4 below can be applied to a case in which a periodicity in Table 3 or FIG. 2 has a value less than 10 ms. When the periodicity exceeds 10 ms (e.g., 20 ms or 30 ms), a number obtained by subtracting 10 ms from the periodicity is added.

TABLE 4
PUSCH transmission timing k for PDCCH scheduling in TDD

| TDD UL/DL | DL subframe n | | | | | | | | | |
|---|---|---|---|---|---|---|---|---|---|---|
| Configuration | 0 | 1 | 2 | 3 | 4 | 5 | 6 | 7 | 8 | 9 |

| | | | | | | |
|---|---|---|---|---|---|---|
| 0 | 4 | 6 | 4 | 6 | | |
| 1 | 8 | 6 | 8 | 6 | | |
| 2 | | 6 | | 6 | | |
| 3 | 4 | | | | 4 | 4 |
| 4 | | | | | 4 | 4 |
| 5 | | | | | 4 | |
| 6 | 7 | 7 | 7 | 7 | | |

Specifically, when a PDCCH monitoring periodicity for each UE has a value less than or equal to 10 ms, k shown in Table 4 is used as it is. When the PDCCH monitoring periodicity for each UE has a value exceeding 10 ms, a timing of a subframe is calculated by adding k in Table 4 to a value obtained by subtracting 10 ms from the PDCCH monitoring periodicity.

Meanwhile, Table 5 below shows a configuration of k_{PHICH} which is a position of a DL subframe including a PHICH including response control information according to PUSCH transmission.

TABLE 5
PHICH timing k_{PHICH} for PUSCH transmission in TDD

| TDD UL/DL | UL subframe m | | | | | | | | | |
|---|---|---|---|---|---|---|---|---|---|---|
| Configuration | 0 | 1 | 2 | 3 | 4 | 5 | 6 | 7 | 8 | 9 |

| | | | | | | |
|---|---|---|---|---|---|---|
| 0 | 4 | 7 | 6 | 4 | 7 | 6 |
| 1 | 4 | 12 | | 4 | 12 | |
| 2 | 4 | | | 4 | | |
| 3 | 6 | 6 | 6 | | | |
| 4 | 6 | 6 | | | | |
| 5 | 6 | | | | | |
| 6 | 4 | 7 | | 4 | 7 | |

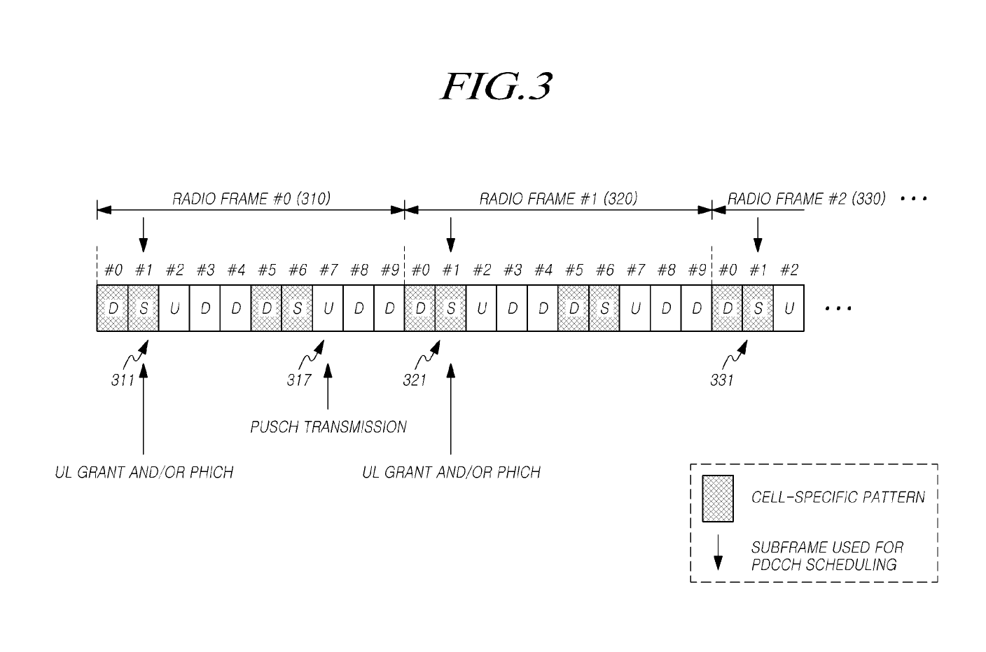

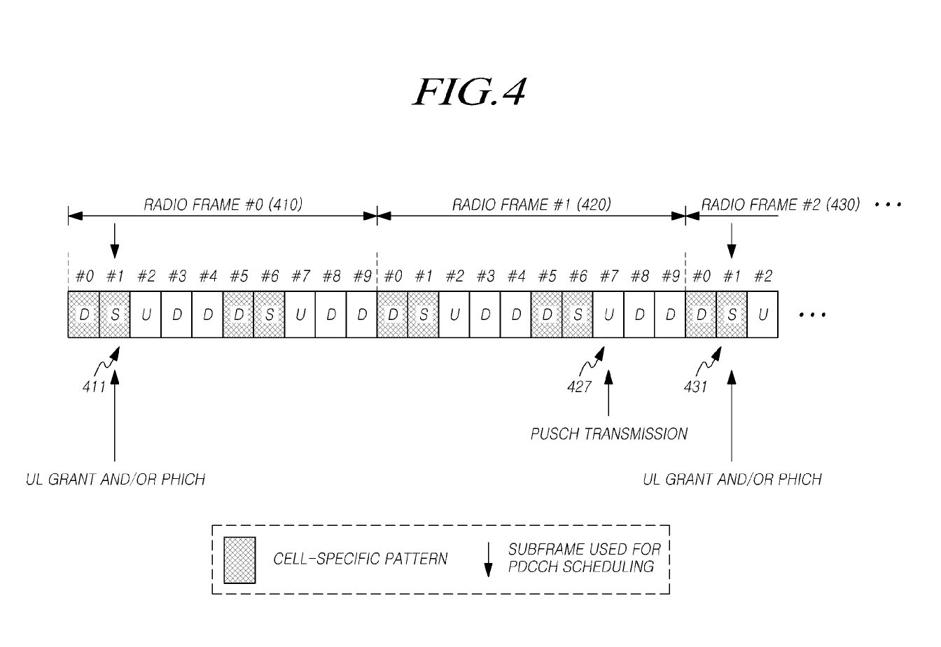

A cell-specific pattern shown in FIGS. 3 and 4 represents the candidate subframes in Table 2.

FIG. 3 is a view illustrating a configuration of UL and DL subframes between a UE and a BS, to which a TDD configuration for low power consumption is applied, according to an embodiment of the present invention.

In FIG. 3 illustrating a case in which a TDD configuration has a value of 2 in Table 2 and PDCCH_{DL}_{_{—}}_{Index} in Table 3 has a value of 5, a periodicity is equal to 10 ms and an offset is equal to 1. Specifically, DL subframes for each cell are subframes #0, #1, #5 and #6 according to Table 2, and the UE monitors a PDCCH in each subframe #1 (i.e., subframes 311, 321 and 331) at a periodicity corresponding to every radio frame (i.e., 10 ms). When the scheduling of a PDCCH by the UE as shown in FIG. 3 is set in the bitmap scheme shown in FIG. 2, the scheduling of the PDCCH by the UE may be represented in a 16-bit bitmap such as “0100010001000100.”

The UE attempts blind decoding according to the PDCCH scheduling in the subframe #1 311 of a radio frame #0 310. When the UE decodes a UL grant and/or receives a PHICH according to a result of the blind decoding, the UE transmits a PUSCH in response to the decoding of the UL grant and/or the reception of the PHICH. At this time, Table 4 may be applied to a timing of the PUSCH transmission. A TDD configuration for each cell has a value of 2 and a DL subframe n in which the UE has received the UL grant through PDCCH monitoring and/or which includes a PHICH is subframe #1. Accordingly, the value of k in Table 4 is equal to 6. Also, because a PDCCH monitoring periodicity of the UE is equal to 10 ms, 7 is obtained by adding 6 which is the value of k to n as it is. Accordingly, a UL timing for the UL grant and/or the PHICH which has been transmitted in the subframe #1 311 of the radio frame #0 310 corresponds to a subframe #7 317 of the radio frame #0 310, and a PUSCH is transmitted.

When the PUSCH is transmitted in the subframe #7 317 of the radio frame #0 310, Table 5 is applied to a timing of a PHICH including response control information to the is transmission of the PUSCH. When a TDD configuration has a value of 2 and UL subframe m is subframe #7 in Table 5, k_{PHICH} has a value of 4. Accordingly, after 4 from the subframe #7 317 of the radio frame #0 310, namely, through a PHICH of the subframe #1 321 of a radio frame #1 320, the response control information to the transmission of the PUSCH may be received. Alternatively, response control information to the transmission of a previous PUSCH may be received as a UL grant in the subframe #1 321 of a radio frame #1 320.

FIG. 4 is a view illustrating a configuration of UL and DL subframes between a UE and a BS, to which a TDD configuration for low power consumption is applied, according to another embodiment of the present invention.

In FIG. 4 illustrating a case in which a cell-specific TDD configuration has a value of 2 in Table 2 as illustrated in FIG. 3 and PDCCH_{DL}_{_{—}}_{Index} in Table 3 has a value of 11, a periodicity is equal to 20 ms and an offset is equal to 1. Specifically, DL subframes for each cell are subframes #0, #1, #5 and #6 according to Table 2, and the UE monitors a PDCCH in subframes #1 (i.e., subframes 411 and 431) at a periodicity corresponding to two radio frames (i.e., 20 ms). When the monitoring of a PDCCH by the UE as shown in FIG. 4 is set in the bitmap scheme shown in FIG. 2, the monitoring of the PDCCH by the UE may be represented in a 16-bit bitmap such as “0100000001000000.”

The UE attempts blind decoding according to the PDCCH monitoring in the subframe #1 411 of a radio frame #0 410. When a UL grant and/or a PHICH is included according to a result of the blind decoding, the UE transmits a PUSCH in response to the included UL grant and/or PHICH. At this time, Table 4 may be applied to a timing of the PUSCH transmission. A TDD configuration for each cell has a value of 2 and a DL subframe n in which the UE has received the UL grant through the PDCCH monitoring and/or which is includes the PHICH is subframe #1. Accordingly, the value of k in Table 4 is equal to 6. Also, because a PDCCH monitoring periodicity of the UE is equal to 20 ms, 17 is obtained by adding 6 which is the value of k to n as it is and by adding 10 obtained by (periodicity−10 ms). Accordingly, a UL timing for the UL grant and/or the PHICH which has been transmitted in the subframe #1 411 of the radio frame #0 410 corresponds to a subframe #7 427 of the radio frame #1 420, and a PUSCH is transmitted.

When the PUSCH is transmitted in the subframe #7 427 of the radio frame #1 420, Table 5 is applied to a timing of a PHICH including response control information to the transmission of the PUSCH. When a TDD configuration has a value of 2 and UL subframe m is subframe #7 in Table 5, k_{PHICH} has a value of 4. Accordingly, after 4 from the subframe #7 427 of the radio frame #1 420, namely, through a PHICH of the subframe #1 431 of a radio frame #2 430, the response control information to the transmission of the PUSCH may be received.

A PUSCH transmission timing according to a TDD configuration as described above is summarized as follows.

First, when the UE has a TDD configuration having a value from 1 to 6 and operates according to a scheme for a normal Hybrid Automatic Repeat reQuest (HARQ) operation, and when the UE has a PDCCH monitoring periodicity (e.g., 1, 5, 8, or 10 ms) shorter than or equal to the length (i.e., 10 ms) of one radio frame, if the UE receives a UL grant and/or a PHICH in subframe n, the UE transmits a PUSCH in UL subframe (n+k) indicated by adding k with subframe n as a reference. This example is the same as described above with reference to FIG. 3.

Meanwhile, when the UE has a TDD configuration having a value from 1 to 6 and has a PDCCH monitoring periodicity (e.g., 20, 30, 40 ms, or the like) longer than the length (i.e., 10 ms) of one radio frame under the scheme for a normal HARQ operation, if the UE receives a UL grant and/or a PHICH in subframe n, the UE transmits a PUSCH in UL shbframe (n+k+(periodicity−10 ms)) indicated by adding k+(periodicity−10 ms) to subframe n. For example, when a PDCCH monitoring periodicity is equal to 30 ms, the UE transmits a PUSCH in UL subframe (n+k+20). This example is the same as described above with reference to FIG. 4.

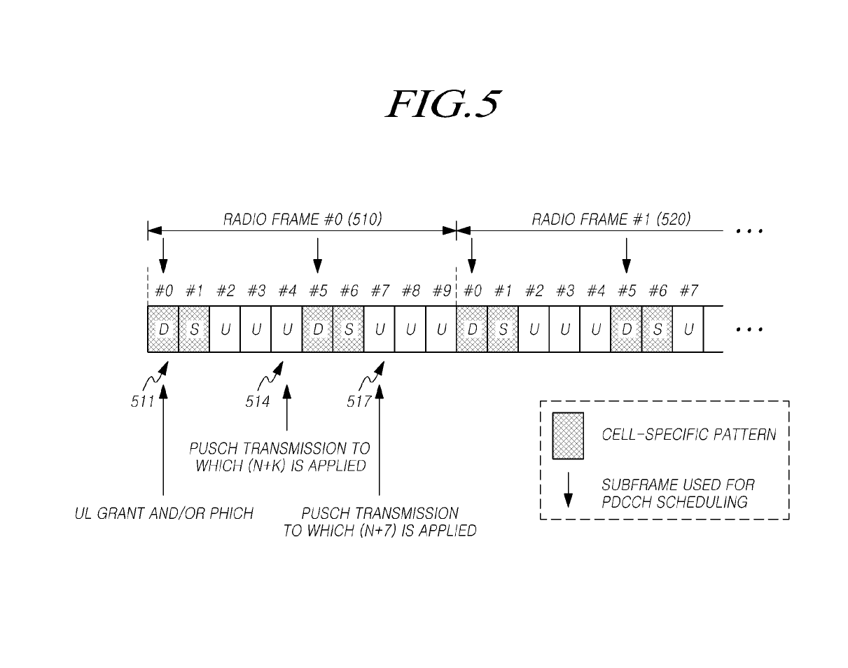

FIG. 5 is a view illustrating an example of transmitting a PUSCH when a TDD configuration has a value of 0 in Table 2 and a PDCCH monitoring periodicity is shorter than or equal to a radio frame, according to an embodiment of the present invention. A cell-specific pattern illustrated in FIG. 5 represents candidate subframes shown in Table 2.

Referring to FIG. 5, because a TDD configuration has a value of 0 in Table 2, cell-specific PDCCH scheduling is performed in subframes #0, #1, #5 and #6 which are candidate subframes in the case of the configuration 0 in Table 2 for each radio frame. PDCCH_{DL}_{_{—}}_{Index} in Table 3 has a value of 0 with respect to PDCCH scheduling (i.e., the monitoring of a PDCCH) which is set for the UE, and thus the UE monitors a PDCCH in subframes #0 and #5. Specifically, in FIG. 5, the UE operates in the scheme for a normal HARQ operation, and has a PDCCH monitoring periodicity of 5 ms shorter than or equal to the length (i.e., 10 ms) of one radio frame. The UE receives a UL grant and/or a PHICH in a subframe #0 511 of a radio frame #0 510. At this time, when the UL grant is a Downlink Control Information (DCI) format 0 or 4, and 1 is set in a Most Significant Bit (MSB) of a UL index of a DCI format 0/4 or it is satisfied to receive a PHICH by using a resource complying with “I_{PHICH}=0” in subframe #0 or #5, if the transmission timing k in Table 4 is calculated with subframe n as a reference, the transmission timing k becomes 4, and a PUSCH is transmitted in a subframe #4 514 of the radio frame #0 510 including subframe (n+4). Although not illustrated in FIG. 5, n+k+(periodicity−10 ms) is applied to a case where a PDCCH monitoring periodicity of the UE is longer than 10 ms. When a monitoring periodicity is equal to 20 ms in FIG. 5, because n+k+10 is applied to this case, a PUSCH may be transmitted in subframe #4 of a radio frame #1 520.

When the UL grant may be in the DCI format 0 or 4, and when 1 is set in a Least Significant Bit (LSB) of the UL index of the DCI format 0/4, or when it is satisfied to receive a PHICH by using a resource complying with “I_{PHICH}=1” in subframe #0 or #5, or when the PHICH is received in subframe #1 or #6, the transmission timing k in Table 4 is not calculated with subframe n as a reference, and a PUSCH is transmitted in a subframe #7 517 of the radio frame #0 510 including subframe (n+7) indicated by adding 7. Although not illustrated in FIG. 5, n+7+(periodicity−10 ms) is applied to a case where a PDCCH monitoring periodicity of the UE is longer than 10 ms. When a monitoring periodicity is equal to 20 ms in FIG. 5, because n+7+10 is applied to this case, a PUSCH may be transmitted in subframe #7 of the radio frame #1 520.

When a TDD configuration has a value of 0, the number of UL subframes existing in one radio frame is equal to 6 as shown in Table 2. Accordingly, because two UL subframes are mapped to one DL subframe, the proposal in FIG. 5 can be applied to the selection of UL subframes for transmitting a PUSCH. It goes without saying that a discrimination scheme illustrated in FIG. 5 is an embodiment of the present invention and in addition, a scheme for selecting a UL subframe between the UE and the BS may be previously set.

A method for variously selecting a UL subframe when a TDD configuration has a value of 0 can be summarized as follows.

When a UL grant and/or a PHICH has been received in subframe n, if, at this time, the received UL grant is in DCI formats 0 and 4 and i) an MSB of a UL index is set to 1 or ii) the PHICH is received by using a resource complying with “I_{PHICH}=0” in subframe #0 or #5, k shown in Table 4 is applied to the transmission of a PUSCH and the transmission of a PUSCH is complies with the following description.

When a periodicity is shorter than or equal to 10 ms, a PUSCH is transmitted in subframe (n+k). When a periodicity is longer than 10 ms, the PUSCH is transmitted in subframe (n+k+(periodicity−10 ms)).

Meanwhile, when a UL grant and/or a PHICH has been received in subframe n, if, at this time, the received UL grant is in DCI formats 0 and 4 and i) an LSB of a UL index is set to 1, or ii) the PHICH is received by using a resource complying with “I_{PHICH}=1” in subframe #0 or #5, or iii) the PHICH is received in subframe #1 or #6, k shown in Table 4 is not applied to the transmission of a PUSCH but 7 is applied to the transmission of a PUSCH as follows.

When a periodicity is shorter than or equal to 10 ms, a PUSCH is transmitted in subframe (n+7). When a periodicity is longer than 10 ms, the PUSCH is transmitted in subframe (n+7+(periodicity−10 ms)).

Meanwhile, when a UL grant and/or a PHICH has been received in subframe n, if, at this time, the received UL grant is in the DCI formats 0 and 4, and if an MSB and an LSB of a UL index are both set to 1, in the case of a periodicity shorter than or equal to 10 ms, the UE transmits a PUSCH in each of subframes (n+k) and (n+7), to which Table 4 is applied. When the periodicity is longer than 10 ms, the UE may transmit a PUSCH in each of subframes (n+k+(periodicity−10 ms)) and (n+7+(periodicity−10 ms)), to which Table 4 is applied.

Meanwhile, embodiments of the present invention in the case of using Transmission Time Interval (TTI) bundling are described as follows. The term “TTI bundling” refers to a method for increasing a UL coverage. In this method, identical data, which all have an identical HARQ process number in 4 consecutive UL subframes, is transmitted in each of the 4 consecutive UL subframes. In this manner, additional signaling overhead can be avoided when re-transmission occurs. Because the identical data is transmitted in each of the 4 consecutive UL subframes, it is possible to improve the reliability of data transmission and a UL coverage due to the reliability of the data transmission. Also, this method is a technique which can be efficiently used in a traffic model sensitive to a time constraint such as Voice over Internet Protocol (VoIP). The number of UL subframes, which is 4 in this example, may be increased or reduced according to the implementation of the TTI bundling method.

When TTI bundling is set for a UE having low power consumption, such as an MTC UE, the monitoring of a PDCCH by each UE may be selected from among subframe sets shown in Table 6 below rather than Table 3 or FIG. 2.

The TTI bundling has a basically long Round Trip Time (RTT) (e.g., 30 ms). Accordingly, the UE for which the TTI bundling is set has scheduling (i.e., monitoring) subframe sets shown in Table 6 below, which are based on one radio frame. It goes without saying that TTI bundling having a periodicity corresponding to a longer radio frame may also allow an offset value to be added by a time increment of the periodicity to each of subframe sets shown in Table 6 below.

TABLE 6
PDCCH scheduling (monitoring) in
UE for which TTI bundling is set

| PDCCH_{ttibundling}_{_{—}}_{DL}_{_{—}}_{Index} | Restricted subframe set for TTI bundling |
|---|---|
| 0 | Subframe {0, 1} |
| 1 | Subframe {1, 5} |
| 2 | Subframe {5, 6} |
| 3 | Subframe {6, 0} |

Because the TTI bundling requires a large number of UL subframes, the following description will focus on TDD configurations 0, 1 and 6. Table 7 below shows a transmission timing of a PHICH and that of a PUSCH, which can be used in the case of setting the TTI bundling.

TABLE 7
Value of transmission timing p

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |

| | | | | |
|---|---|---|---|---|
| 0 | 9 | 6 | 9 | 6 |
| 1 | 9 | 6 | 9 | 6 |
| 6 | 5 | 5 | 6 | 6 |

An example will be described in which TTI bundling is set according to a PUSCH transmission timing p proposed in Table 7.

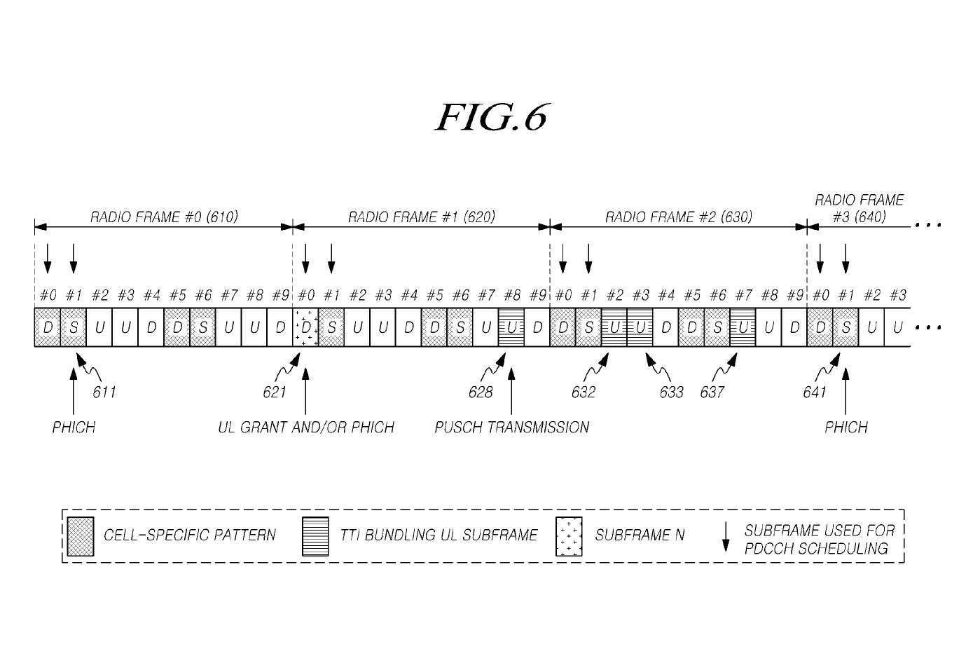

FIG. 6 is a view illustrating an example of the transmission of a PUSCH by a UE for low power consumption when TTI bundling is set, according to an embodiment of the present invention.

In FIG. 6 illustrating a case in which a TDD configuration has a value of 1, PDCCH_{ttibundling}_{_{—}}_{DL}_{_{—}}_{Index} has a value of 0 and a periodicity is equal to 10 ms, the UE monitors a PDCCH in each of subframes #0 and #1 of every radio frame. Herein, a TTI bundling size is equal to 4, and a HARQ process is performed in four UL subframes. Subframe n which is set as a reference is a subframe #0 621 of a radio frame #1 620, and the subframe #0 621 is used to receive a UL grant and/or a PHICH. A DL subframe used to transmit a PHICH, in which HARQ operates, can be calculated by using the value of a PHICH timing p in Table 7, with is respect to the UL grant received in the subframe #0 621. Specifically, the subframe #0 621 of the radio frame #1 620 has a TDD configuration of 1, p has a value of 9 because of subframe #0, and an identification is made of the value of the PHICH transmitted in a subframe #1 611 of a radio frame #0 610 indicated by subtracting p from subframe n. Then, Table 4 may be applied to UL subframes for 4 HARQ processes according to the UL grant in the subframe #n 621. Because the subframe #n 621 is subframe #0 according to the TDD configuration having a value of 1, k has a value of 8. Accordingly, 4 HARQ processes are performed according to the TTI bundling in 4 UL subframes starting from a subframe #8 628 of the radio frame #1 620, which is spaced apart from the subframe #n 621 by 8, and 632, 633, 637.

The TTI bundling is summarized as follows. A TDD configuration having a value of 0 is not changed, but TDD 1 and TDD 6 are changed according to the above-described cell-specific pattern.

When the TTI bundling is set, the TDD configurations 1 and 6 may determine a PUSCH transmission timing related to PHICH transmission in subframe (n−p), as subframe (n+k) by using p calculated with the application of Table 7 and by using the value of k calculated in Table 4.

Similarly, even when the TTI bundling is set, if a UL grant is received downwardly in subframe n for a synchronous HARQ operation, identical data is repeatedly is transmitted in each of 4 consecutive UL subframes, from subframe (n+k) to which Table 4 is applied. With respect to UL subframe t which has been lastly transmitted from among the 4 consecutive UL subframes, a PHICH is transmitted in subframe #1 641 of a radio frame #3 640, which is subframe t+k_{PHICH} according to a PHICH timing shown in Table 5.

Table 7 indicates a relevant PHICH subframe before subframe n for the synchronous HARQ. In other words, when the TTI bundling is set, subframe np corresponds to a PHICH timing.

In this regard, it is noted that actually-scheduled subframes are set as a set (or a pair) as shown in Table 6 when the TTI bundling is set. Specifically, the subframe sets are set as {0, 1}, {1, 5}, {5, 6} and {6, 0}, and only the 4 subframe sets can be used together with the TTI bundling in the TDD configurations 0, 1 and 6 in this manner.

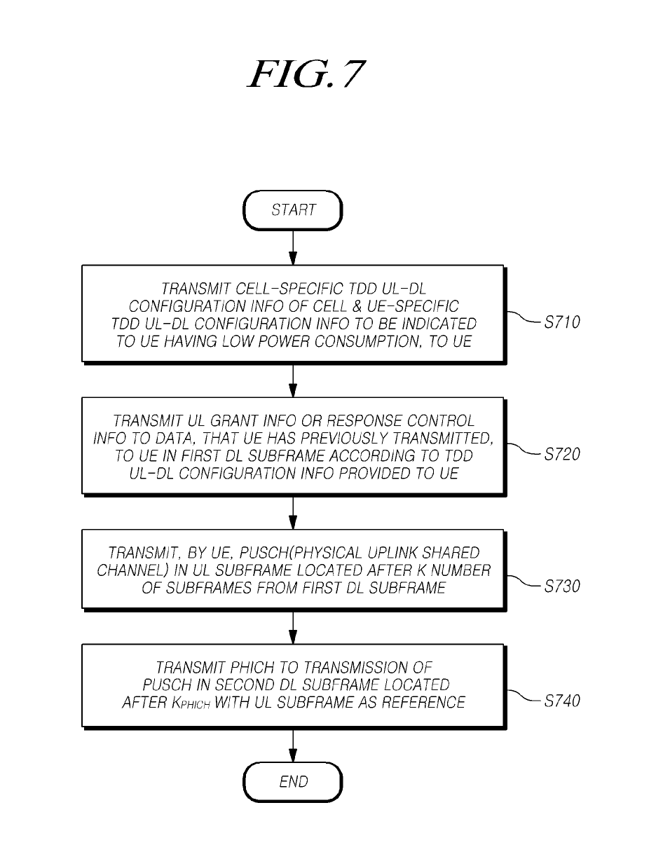

FIG. 7 is a flowchart illustrating a process in which a BS limits a downlink subframe and transmits/receives information to/from a UE through the limited DL subframe in a TDD mode, according to an embodiment of the present invention. FIG. 7 illustrates a case in which the TTI bundling is not used.

Referring to FIG. 7, the BS controls a cell operating in a TDD scheme.

The BS transmits, to the UE having low power consumption connecting to the cell, cell-specific TDD UL-DL configuration information of the cell and UE-specific TDD UL-DL configuration information to be indicated to the UE, in step S710. The cell-specific TDD UL-DL configuration information may be TDD configuration information, which limits PDCCH scheduling (i.e., the transmission of a PDCCH by the BS) in a unit of cell as shown in Table 2. The UE-specific TDD UL-DL configuration information is information on a DL subframe in which the UE can perform PDCCH scheduling (i.e., monitoring) as in the scheme shown in Table 3 and FIG. 2. The UE-specific TDD UL-DL configuration information indicates any one or more of candidate subframes corresponding to some of DL subframes in the relevant cell, and may include a periodicity and subframe information, which enable the PDCCH scheduling. The cell-specific TDD UL-DL configuration information may be provided as system information, and the UE-specific TDD UL-DL configuration information may be provided to the UE through RRC signaling.

In a first DL subframe according to the TDD UL-DL configuration information provided to the UE, the BS transmits, to the UE, UL grant information or response control information to data that the UE has previously transmitted, in step S720. The phase “according to the TDD UL-DL configuration information provided to the UE” signifies the transmission of a UL grant or response control information, such as a PHICH, in a DL subframe at a time point (a time point for being subjected to scheduling) when the UE having low power consumption monitors a PDCCH by using the cell-specific TDD UL-DL configuration information and the UE-specific TDD UL-DL configuration information. The UE transmits a PUSCH in a UL subframe located after a k number of subframes from the first DL subframe, in step S730. The value of k is determined as shown above in Table 4. Also, when a PDCCH monitoring periodicity is longer than the length of a radio frame which is set as the reference in the cell-specific TDD UL-DL configuration (e.g., longer than or equal to 10 ms), a UL subframe may be identified by using a value obtained by adding, to the value of k, a value obtained by subtracting the length of the radio frame from the periodicity.

Then, the BS transmits a PHICH to the transmission of the PUSCH in a second DL subframe located after k_{PHICH} shown Table 5 with the UL subframe as a reference, in step S740.

k and k_{PHICH} illustrated in FIG. 7, which are determined according to a periodicity for the PDCCH scheduling (the monitoring of a PDCCH by the UE) and the cell-specific TDD UL-DL configuration information, have been described above in Table 3 and FIG. 2.

Meanwhile, when the number of UL subframes is equal to or greater than two times that of DL subframes in the TDD configuration as in the case of setting TDD to 0, k may be implemented so as to have a value of 7 according to a particular bit of UL grant information provided in the first DL subframe, or according to a subframe in which the PHICH has been received.

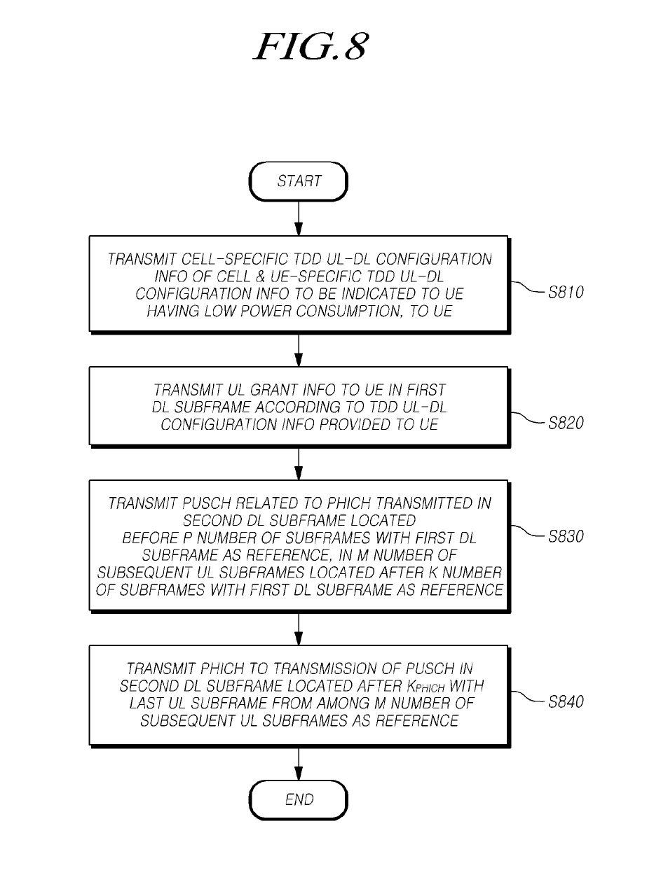

FIG. 8 is a flowchart illustrating a process in which a BS limits a DL subframe and transmits/receives information to/from a UE through the limited DL subframe in a TDD mode, according to an embodiment of the present invention. FIG. 8 illustrates a case in which the TTI bundling is used.

Because step S810 is identical to step S710 illustrated in FIG. 7, a description of step S810 is intended to be replaced by that of step S710 illustrated in FIG. 7.

In a first DL subframe according to the TDD UL-DL configuration information provided to the UE, the BS transmits UL grant information to the UE, in step S820.

When the BS transmits the UL grant information in the first DL subframe, in order to perform PUSCH transmission related to a PHICH transmitted in a second DL subframe located before a p number of subframes as shown in Table 7 with the first DL subframe as a reference, the UE transmits a PUSCH in an m number of subsequent UL subframes located after a k number of subframes with the first DL subframe as a reference. As described above, FIG. 6 illustrates the case in which m is equal to 4. Then, the BS transmits a PHICH to the PUSCH is transmission in a second DL subframe located after k_{PHICH} with a last UL subframe from among the m number of subsequent UL subframes as a reference. With reference to FIG. 6, the description has been made of the process for transmitting a PHICH including response control information to the PUSCH transmission performed in the UL subframes, in a DL subframe located after k_{PHICH} shown in Table 5 with the last UL subframe as a reference.

An example shown in Table 6 may be applied to the PDCCH scheduling (the monitoring of a PDCCH by the UE) in the case of TTI bundling as illustrated in FIG. 8. Meanwhile, when the number of UL subframes is equal to or greater than two times that of DL subframes in the TDD configuration as in the case of setting TDD to 0, k may be implemented so as to have a value of 7 according to a particular bit of the UL grant information provided in the first DL subframe, or according to a subframe in which the PHICH has been received.

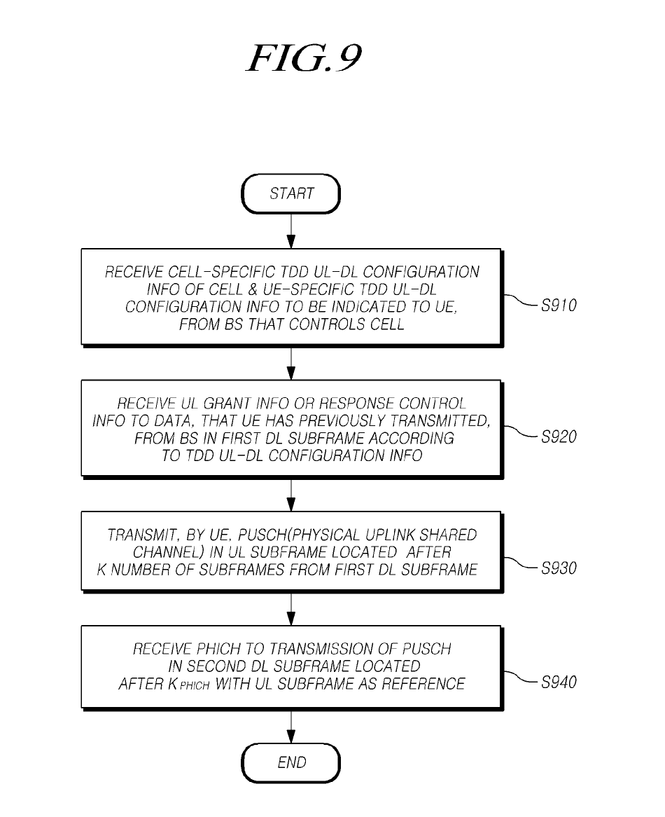

FIG. 9 is a flowchart illustrating a process in which a UE having low power consumption transmits/receives information to/from a base station through a candidate subframe s obtained by limiting a DL subframe in a TDD mode, according to an embodiment of the present invention. FIG. 9 illustrates a case in which the TTI bundling is not used.

Referring to FIG. 9, the BS controls a cell operating in the TDD scheme.

The UE having low power consumption connecting to the cell receives, from the BS, cell-specific TDD UL-DL configuration information of the cell and UE-specific TDD UL-DL configuration information to be indicated to the UE, in step S910. The cell-specific TDD UL-DL configuration information may be TDD configuration information, which limits PDCCH scheduling (i.e., PDCCH transmission) in a unit of cell as shown in Table 2. The UE-specific TDD UL-DL configuration information is information on a DL subframe in which the UE can perform PDCCH monitoring as in the scheme shown in Table 3 and FIG. 2. The UE-specific TDD UL-DL configuration information indicates any one or more of candidate subframes corresponding to some of DL subframes in the relevant cell, and may include a periodicity and subframe information, which enable the PDCCH scheduling. The cell-specific TDD UL-DL configuration information may be provided as system information, and the UE-specific TDD UL-DL configuration information may be provided to the UE through RRC signaling.

In a first DL subframe according to the received TDD UL-DL configuration information, the UE receives, from the BS, UL grant information or response control information to data that the UE has previously transmitted, in step S920. The phase “according to the received TDD UL-DL configuration information” signifies the reception of a UL grant or response control information, such as a PHICH, in a DL subframe at a time point (i.e., a time point when the UE can be subjected to scheduling) when the UE having low power consumption monitors a PDCCH by using the cell-specific TDD UL-DL configuration information and the UE-specific TDD UL-DL configuration information. In other words, because the UE can previously identify a time point when the UE is to monitor a PDCCH by using the previously-received cell-specific TDD UL-DL configuration information and UE-specific TDD UL-DL configuration information, the UE can proceed with a PDCCH monitoring process by performing wake-up and the like at the relevant time point. When a UL grant or PHICH transmission occurs in the first DL subframe, the UE transmits a PUSCH in a UL subframe located after a k number of subframes from the first DL subframe, in step S930. The value of k is determined as shown above in Table 4. Also, when a PDCCH scheduling periodicity is longer than the length of a radio frame which is set as the reference in the cell-specific TDD UL-DL configuration (e.g., longer than or equal to 10 ms), the UE may identify a UL subframe by using a value is obtained by adding, to the value of k, a value obtained by subtracting the length of the radio frame from the periodicity.

Then, the UE receives a PHICH to the transmission of the PUSCH in a second DL subframe located after k_{PHICH} shown Table 5 with the UL subframe as a reference, in step S940.

k and k_{PHICH} illustrated in FIG. 9, which are determined according to the

PDCCH scheduling periodicity and the cell-specific TDD UL-DL configuration information, have been described in Table 3 and FIG. 2.

Meanwhile, when the number of UL subframes is equal to or greater than two times that of DL subframes in the TDD configuration as in the case of setting TDD to 0, k may be implemented so as to have a value of 7 according to a particular bit of UL grant information provided in the first DL subframe, or according to a subframe in which the PHICH has been received.

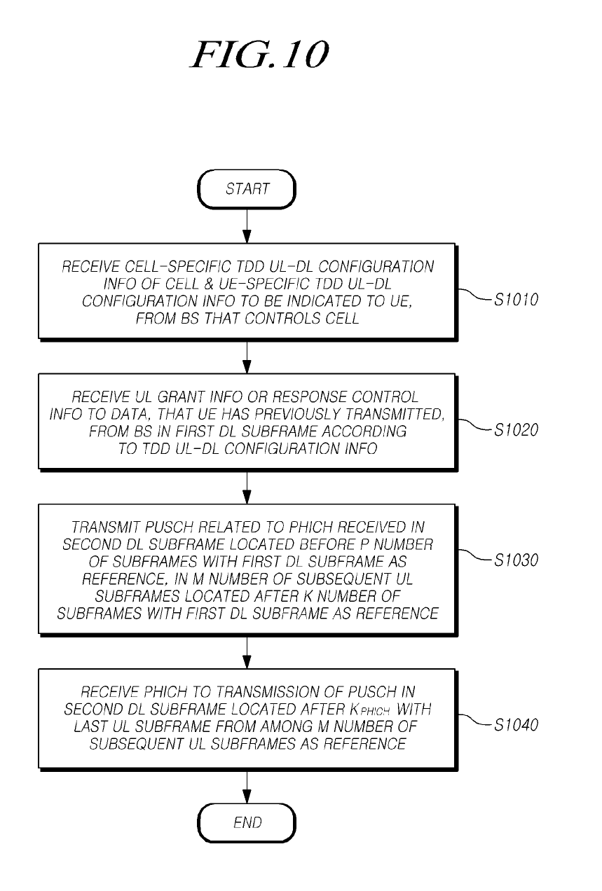

FIG. 10 is a flowchart illustrating a process in which a UE having low power consumption limits a DL subframe and transmits/receives information to/from a base station through the limited DL subframe in a TDD mode, according to an embodiment of the present invention. FIG. 10 illustrates a case in which the TTI bundling is used.

Because step S1010 is identical to step s910 illustrated in FIG. 9, a description of step S1010 is intended to be replaced by that of step s910 illustrated in FIG. 9.

As a result of performing PDCCH monitoring in a first DL subframe according to the TDD UL-DL configuration information, UL grant information is transmitted to the UE in step S1020.

When the UE receives the UL grant information in the first DL subframe, in is order to perform PUSCH transmission related to a PHICH received in a second DL subframe located before a p number of subframes as shown in Table 7 with the first DL subframe as a reference, the UE transmits a PUSCH in an m number of subsequent UL subframes located after a k number of subframes with the first DL subframe as a reference. As described above, FIG. 6 illustrates the case in which m is equal to 4. Then, the UE receives a PHICH to the PUSCH transmission in a second DL subframe located after k_{PHICH} with a last UL subframe from among the m number of subsequent UL subframes as a reference. With reference to FIG. 6, the description has been made of the process for transmitting a PHICH including response control information to the PUSCH transmission performed in the UL subframes, in a DL subframe located after k_{PHICH} shown in Table 5 with the last UL subframe as a reference.

An example shown in Table 6 may be applied to the PDCCH monitoring in the case of TTI bundling as illustrated in FIG. 8. Meanwhile, when the number of UL subframes is equal to or greater than two times that of DL subframes in the TDD configuration as in the case s of setting TDD to 0, k may be implemented so as to have a value of 7 according to a particular bit of the UL grant information provided in the first DL subframe, or according to a subframe in which the PHICH has been received.

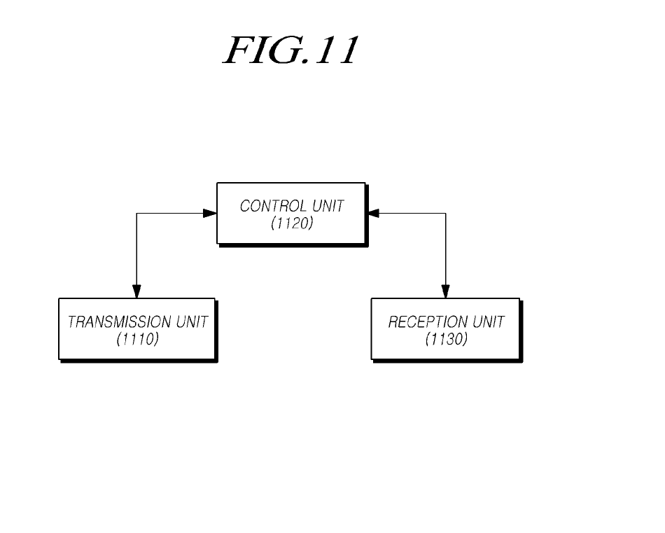

FIG. 11 is a block diagram illustrating a configuration of a BS according to an embodiment of the present invention.

The BS which controls a cell operating in the TDD scheme includes a transmission unit 1110, a reception unit 1130, and a control unit 1120 which controls the transmission unit 1110 and the reception unit 1130. The transmission unit 1110 transmits a wireless signal to the UE, and the reception unit 1130 receives a wireless signal from the UE.

The control unit 1120 generates cell-specific TDD UL-DL configuration is information of the cell and UE-specific TDD UL-DL configuration information to be indicated to the UE having low power consumption with respect to the UE, and controls the transmission unit 1110 to transmit the generated cell-specific TDD UL-DL configuration information and UE-specific TDD UL-DL configuration information to the UE. The control unit 1120 controls the transmission unit 1110 to transmit UL grant information or response control information to data that the BS has previously received from the UE, to the UE in a first DL subframe according to the TDD UL-DL configuration information provided to the UE. Here, the UE-specific TDD UL-DL configuration information may indicate any one or more of candidate subframes corresponding to some of DL subframes in the cell.

As described above with reference to FIGS. 3, 4, 5, 6, 7 and 8, the BS illustrated in FIG. 11 provides the UE having low power consumption with the TDD UL-DL configuration information and the PDCCH scheduling (i.e., PDCCH transmission) information, and transmits a UL grant, a PHICH, or the like according the scheduling.

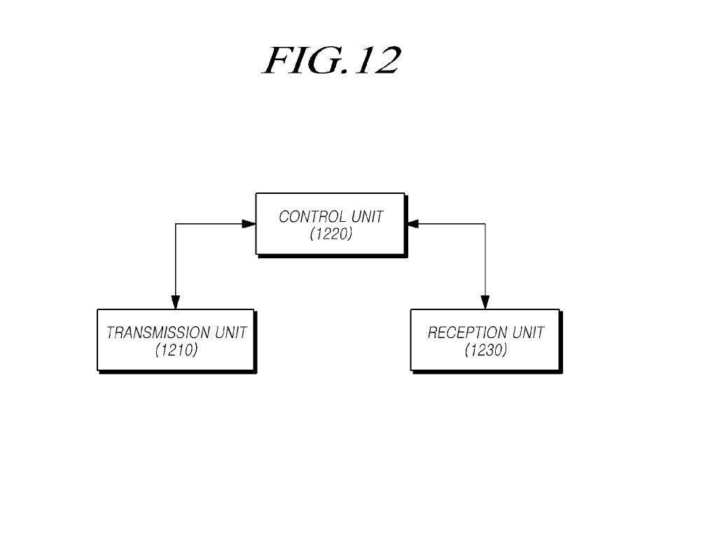

FIG. 12 is a block diagram illustrating a configuration of a UE having low power consumption according to an embodiment of the present invention.

The UE having low power consumption connecting to a cell operating in the TDD scheme includes a transmission unit 1210, a reception unit 1230, and a control unit 1220 which controls the transmission unit 1210 and the reception unit 1230. The transmission unit 1210 transmits a wireless signal to the BS, and the reception unit 1230 receives a wireless signal from the BS.

When the reception unit 1230 receives, from the BS controlling the cell, cell-specific TDD UL-DL configuration information of the cell and UE-specific TDD UL-DL configuration information to be indicated to the UE, the control unit 1220 controls the reception is unit 1230 to receive UL grant information or response control information to data that the UE has previously transmitted, from the BS in a first DL subframe according to the TDD UL-DL configuration information. Here, the UE-specific TDD UL-DL configuration information may indicate any one or more of candidate subframes corresponding to some of DL subframes in the cell.

As described above with reference to FIGS. 3, 4, 5, 6, 9 and 10, the UE illustrated in FIG. 12 which consumes low power, receives TDD UL-DL configuration information and PDCCH monitoring information from the BS, provides the received information, and receives a UL grant or a PHICH according to the scheduling (i.e., a result of the monitoring).

According to embodiments of the present invention, the UE monitors a particular DL subframe by limiting an attempt of PDCCH blind decoding on the UE requiring low power consumption such as an MTC UE, so that battery consumption of the UE can be minimized. The minimization of battery consumption of the UE is appropriate for a system, such as an MTC system, which is oriented to intermittent communication

The above description is only an illustrative description of the technical idea of the present invention, and those having ordinary knowledge in the technical field, to which the present invention pertains, will appreciate that various changes and modifications may be made to the embodiments described herein without departing from the essential features of the present invention. Therefore, the embodiments disclosed in the present invention are intended not to limit but to describe the technical idea of the present invention, and thus do not limit the scope of the technical idea of the present invention. The protection scope of the present invention should be construed based on the appended claims, and all of the technical ideas included within the is scope equivalent to the appended claims should be construed as being included within the right scope of the present invention.

1. A method for limiting a downlink subframe in a Time Division Duplex (TDD) mode by a Base Station (BS) that controls a cell operating in a TDD scheme, the method comprising:
transmitting cell-specific TDD uplink-downlink (UL-DL) configuration information of the cell and User Equipment (UE)-specific TDD UL-DL configuration information to a UE having low power consumption; and
transmitting UL grant information or response control information to data which has previously been received from the UE, to the UE in a first DL subframe according to the cell-specific TDD UL-DL configuration information and the UE-specific TDD UL-DL configuration information provided to the UE,
wherein the UE-specific TDD UL-DL configuration information indicates any one or more of candidate subframes corresponding to some of DL subframes in the cell.

2. The method as claimed in claim 1, wherein the UE-specific TDD UL-DL configuration information corresponds to information on a DL subframe, in which the UE is to monitor a Physical Downlink Control CHannel (PDCCH).

3. The method as claimed in claim 2, wherein the response control information is transmitted through a Physical Hybrid Automatic Repeat reQuest (HARQ) Indicator CHannel (PHICH);
wherein, after the transmitting of the UL grant information or the PHICH in the first DL subframe, the UE transmits a Physical Uplink Shared CHannel (PUSCH) in a UL subframe located after a k number of subframes from the first DL subframe; and
wherein a PHICH to the transmission of the PUSCH is transmitted in a second DL subframe located after k_{PHICH} with the UL subframe as a reference, wherein the k and the k_{PHICH} are determined according to a periodicity for monitoring the PDCCH and the cell-specific TDD UL-DL configuration information.

4. The method as claimed in claim 2, wherein the response control information is transmitted through a Physical Hybrid Automatic Repeat reQuest (HARQ) Indicator CHannel (PHICH);
wherein the UE performs a HARQ process and transmits a Physical Uplink Shared CHannel (PUSCH) in an m number of UL subframes according to Transmission Time Interval (TTI) bundling;
wherein, after the transmitting of the UL grant information in the first DL subframe, in order to perform PUSCH transmission related to a PHICH received in a second DL subframe located before a p number of subframes with the first DL subframe as a reference, the UE transmits a PUSCH in an m number of subsequent UL subframes located after a k number of subframes with the first DL subframe as a reference; and
wherein a PHICH to the transmission of the PUSCH is transmitted in a second DL subframe located after k_{PHICH} with a last UL subframe from among the m number of subsequent UL subframes as a reference, wherein the k and the k_{PHICH} are determined according to a periodicity for monitoring the PDCCH and the cell-specific TDD UL-DL configuration information.

5. The method as claimed in claim 3, wherein, when the periodicity is longer than a length of a radio frame which is set as a reference in the cell-specific TDD UL-DL configuration, a value obtained by subtracting the length of the radio frame from the periodicity is added to the k.

6. The method as claimed in claim 3, wherein, when the number of UL subframes is equal to or greater than two times the number of DL subframes in the TDD UL-DL configuration, the k has a value of 7 according to a particular bit of the UL grant information provided in the first DL subframe, or according to a subframe in which the PHICH has been received.

7. A method for limiting a downlink subframe in a Time Division Duplex (TDD) mode by a User Equipment (UE) having low power consumption connecting to a cell operating in a TDD scheme, the method comprising:
receiving cell-specific TDD uplink-downlink (UL-DL) configuration information of the cell and UE-specific TDD UL-DL configuration information, from a Base Station (BS) that controls the cell; and
receiving UL grant information or response control information to data which the UE has previously transmitted, from the BS in a first DL subframe according to the cell-specific TDD UL-DL configuration information and the UE-specific TDD UL-DL configuration information,
wherein the UE-specific TDD UL-DL configuration information indicates any one or more of candidate subframes corresponding to some of DL subframes in the cell.

8. The method as claimed in claim 7, wherein the UE-specific TDD UL-DL configuration information corresponds to information on a DL subframe, in which the UE is to monitor a Physical Downlink Control CHannel (PDCCH).

9. The method as claimed in claim 8, wherein the response control information is transmitted through a Physical Hybrid Automatic Repeat reQuest (HARQ) Indicator CHannel (PHICH);
wherein, after the receiving of the UL grant information or the PHICH in the first DL subframe, the UE transmits a Physical Uplink Shared CHannel (PUSCH) in a UL subframe located after a k number of subframes from the first DL subframe; and
wherein a PHICH to the transmission of the PUSCH is received in a second DL subframe located after k_{PHICH} with the UL subframe as a reference,
wherein the k and the k_{PHICH} are determined according to a periodicity for monitoring the PDCCH and the cell-specific TDD UL-DL configuration information.

10. The method as claimed in claim 8, wherein the response control information is transmitted through a PHICH;
wherein the UE performs a HARQ process and transmits a PUSCH in an m number of UL subframes according to Transmission Time Interval (TTI) bundling;
wherein, after the receiving of the UL grant information in the first DL subframe, in order to perform PUSCH transmission related to a PHICH received in a second DL subframe located before a p number of subframes with the first DL subframe as a reference, the UE transmits a PUSCH in an m number of subsequent UL subframes located after a k number of subframes with the first DL subframe as a reference; and
wherein a PHICH to the transmission of the PUSCH is received in a second DL subframe located after k_{PHICH} with a last UL subframe from among the m number of subsequent UL subframes as a reference,
wherein the k and the k_{PHICH} are determined according to a periodicity for monitoring the PDCCH and the cell-specific TDD UL-DL configuration information.

11. The method as claimed in claim 9, wherein, when the periodicity is longer than a length of a radio frame which is set as a reference in the cell-specific TDD UL-DL configuration, a value obtained by subtracting the length of the radio frame from the periodicity is added to the k.

12. The method as claimed in claim 9, wherein, when the number of UL subframes is equal to or greater than two times the number of DL subframes in the TDD UL-DL configuration, the k has a value of 7 according to a particular bit of the UL grant information provided in the first DL subframe, or according to a subframe in which the PHICH has been received.

13. A Base Station (BS) that controls a cell operating in a Time Division Duplex (TDD) scheme, the BS comprising:
a transmission unit that transmits a wireless signal to a User Equipment (UE);
a reception unit that receives a wireless signal from the UE; and
a control unit that controls the transmission unit and the reception unit,
wherein the control unit generates cell-specific TDD uplink-downlink (UL-DL) configuration information of the cell and UE-specific TDD UL-DL configuration information with respect to the UE having low power consumption, and controls the transmission unit to transmit the generated cell-specific TDD UL-DL configuration information and UE-specific TDD UL-DL configuration information to the UE; and
wherein the control unit controls the transmission unit to transmit UL grant information or response control information to data that the BS has previously received from the UE, to the UE in a first DL subframe according to the cell-specific TDD UL-DL configuration information and the UE-specific TDD UL-DL configuration information, which are provided to the UE,
wherein the UE-specific TDD UL-DL configuration information indicates any one or more of candidate subframes corresponding to some of DL subframes in the cell.

14. A User Equipment (UE) having low power consumption connecting to a cell operating in a Time Division Duplex (TDD) scheme, the UE comprising:
a transmission unit that transmits a wireless signal to a Base Station (BS);
a reception unit that receives a wireless signal from the BS; and
a control unit that controls the transmission unit and the reception unit,
wherein the reception unit receives cell-specific TDD uplink-downlink (UL-DL) configuration information of the cell and UE-specific TDD UL-DL configuration information, from the BS that controls the cell; and
wherein the control unit controls the reception unit to receive UL grant information or response control information to data that the UE has previously transmitted, from the BS in a first DL subframe according to the cell-specific TDD UL-DL configuration information and the UE-specific TDD UL-DL configuration information,
wherein the UE-specific TDD UL-DL configuration information indicates any one or more of candidate subframes corresponding to some of DL subframes in the cell.

15. The method as claimed in claim 4, wherein, when the periodicity is longer than a length of a radio frame which is set as a reference in the cell-specific TDD UL-DL configuration, a value obtained by subtracting the length of the radio frame from the periodicity is added to the k.

16. The method as claimed in claim 4, wherein, when the number of UL subframes is equal to or greater than two times the number of DL subframes in the TDD UL-DL configuration, the k has a value of 7 according to a particular bit of the UL grant information provided in the first DL subframe, or according to a subframe in which the PHICH has been received.

17. The method as claimed in claim 10, wherein, when the periodicity is longer than a length of a radio frame which is set as a reference in the cell-specific TDD UL-DL configuration, a value obtained by subtracting the length of the radio frame from the periodicity is added to the k.

18. The method as claimed in claim 10, wherein, when the number of UL subframes is equal to or greater than two times the number of DL subframes in the TDD UL-DL configuration, the k has a value of 7 according to a particular bit of the UL grant information provided in the first DL subframe, or according to a subframe in which the PHICH has been received.
